(19) United States
(12) Patent Application Publication
(10) Pub. No.: US 2025/0034819 A1
(43) Pub. Date: Jan. 30, 2025

(54) SYSTEM AND METHOD FOR CREATING CUSTOM SURFACES

(71) Applicant: Mitchell Andrew TRUBAN, SIGNAL MOUNTAIN, TN (US)

(72) Inventor: Mitchell Andrew TRUBAN, SIGNAL MOUNTAIN, TN (US)

(21) Appl. No.: 18/787,609

(22) Filed: Jul. 29, 2024

Related U.S. Application Data
(60) Provisional application No. 63/516,319, filed on Jul. 28, 2023.

(51) Int. Cl. E01C 13/08; B29C 39/10; F21V 33/00; F21W 131/105; F21Y 115/10; H05B 47/105

(52) U.S. Cl. CPC E01C 13/08; F21V 33/006; H05B 47/105; B29C 39/10; F21V 2200/15; F21W 2131/105; F21Y 2115/10

(57) ABSTRACT

An artificial surface includes a substrate configured to support the artificial surface, a plurality of fibers formed integrally with and protruding upward from the substrate, wherein each of the plurality of fibers is individually molded. and a controller coupled to one or more of the plurality of fibers, wherein the controller is configured to control technology embedded in the one or more of the plurality of the fibers.

### CROSS-REFERENCE TO RELATED APPLICATIONS

This application claims the benefit of U.S. provisional Patent Application No. 63/516,319, filed Jul. 28, 2023, which is incorporated by reference in its entirety.

### TECHNICAL FIELD

This disclosure is directed to systems and methods for creating new surfaces with properties relating to increased sustainability, durability, color fastness, and embedded technology.

### BACKGROUND

In the flooring industry, the machinery and raw materials have been unchanged from their core components in decades. They have multiple components that are assembled together through a tufting or weaving process. This process makes future innovation with technology difficult. The process also creates complexities around the sustainability because of the different components. Traditional surfaces are typically made from nylon, polyester, polypropylenes, and polyethylene, with tufters, weavers or knitters to combine the products together. This application then requires a coating or an adhesive of some kind to bind them all together.

Artificial turf for sports fields, and landscapes or other applications typically are formed using extrusion molds, making one size fits all simulated blades of grass. One prior art system taught in US 2021/0108376 includes fibers integrally formed on a substrate using an injection molding process.

However, nothing in the prior art includes individual fibers that can be created that actually resemble real grass having a stem and leaves. Also, there is nothing in the prior art that includes the ability to have different color and properties throughout the surface. Accordingly, there is a need for innovation in the industry to create more realistic turf fields and other custom surfaces that look realistic and incorporate technology to provide other customizations.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

The present disclosure is directed to an artificial surface including a substrate configured to support the artificial surface, a plurality of fibers formed integrally with and protruding upward from the substrate, wherein each of the plurality of fibers is individually molded, and a controller coupled to one or more of the plurality of fibers. In an aspect, the artificial surface may further include one or more pixels embedded in the one or more of the plurality of fibers, and wherein the controller is a red-green-blue (RGB) controller is configured to control a light emanating from the one or more pixels to create a first pattern. The RGB controller may be configured to change the light emanating from the one or more pixels to create a second pattern. The first pattern may include layout of a first sports field and the second pattern may include a layout of a second sports field. In another aspect, the first pattern is a first design, and wherein the controller is configured to change the light emanating from the one or more pixels to create a second pattern, wherein the second pattern is a second design. The artificial surface as described above may further include one or more pressure sensors embedded in the one or more of the plurality of fibers. In an aspect, the RGB controller may be further configured to (a) receive a pressure reading from the one or more pressure sensors, (b) compare the pressure reading to a threshold, and (c) create a signal based on the comparing step.

The present disclosure is also directed to an artificial surface including a substrate configured to support the artificial surface, a plurality of fibers formed integrally with and protruding upward from the substrate, wherein each of the plurality of fibers is individually molded and wherein a first subset of the plurality of fibers includes a first shape and a second subset of the plurality of fibers includes a second shape. The characteristics of the plurality of fibers may be adjusted based on individual molds for the plurality of fibers, wherein the characteristics are one of density, height or flexibility of the fibers. The plurality of fibers may be configured to resemble one or more types of grass. The artificial surface may include a first subset of the plurality of fibers having a first color and a second subset of the plurality of fibers having a second color. In an embodiment, the one or more of the plurality of fibers may have a scent embedded therein.

The present disclosure is also directed to a method for creating a custom surface including designing a configuration of fibers, configuring a cast-in-place production line based on the configuration of fibers, wherein the cast-in-place production line includes molds for individual fibers and an integral substrate, filling the molds with a compound, and adding technology to one or more of the molds. In an aspect, the adding technology step includes adding technology within one or more of the molds for individual fibers and adding technology to the substrate. The adding technology within the one or more of the molds for individual fibers may include one or more pixels and the technology in the substrate may include a connection between the one or more of the molds for individual fibers having the one or more pixels and wherein the connection is configured to be in communication with a controller. In an aspect, the adding technology within the one or more of the molds for individual fibers may include one or more pressure sensors and the technology in the substrate may include one or more connections between the one or more of the molds for individual fibers having the one or more pressure sensors and wherein the connection is configured to be in communication with a controller. In an aspect, the adding technology step may include adding photovoltaic cells to the one or more of the molds or to the substrate. The compound may include a light reflecting property.

The present disclosure is also directed to an artificial surface including a substrate configured to support the artificial surface, a plurality of fibers formed integrally with and protruding upward from the substrate, wherein each of the plurality of fibers is individually molded, one or more pressure sensors embedded in the one or more of the plurality of fibers, and a controller coupled to one or more of the plurality of fibers. The controller may be configured to (a) receive a pressure reading from the one or more pressure sensors, (b) compare the pressure reading to a threshold, and (c) create a signal based on the comparing step.

### BRIEF DESCRIPTION OF THE DRAWINGS

Reference will now be made to the accompanying drawings, which are not necessarily drawn to scale. In the drawings, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 is an exemplary picture showing synthetic turf in accordance with the present disclosure.

FIG. 2 is an exemplary depiction of a blade of turf in accordance with the present disclosure.

FIGS. 3a and 3b are two views of an exemplary panel of synthetic turf showing multiple blades of turf shown in FIG. 2.

FIG. 4 is an exemplary depiction of multiple leaves on a single blade of synthetic turf.

FIG. 5 is an exemplary flow chart depicting a method of creating a custom surface in accordance with the present disclosure.

FIG. 6 is an exemplary schematic diagram showing a network embedded in a substrate and connected to a controller in accordance with the present disclosure.

FIG. 7 is an exemplary schematic diagram showing pressure sensors as a use case for tennis in accordance with the present disclosure.

FIG. 8 is an exemplary schematic diagram showing solar energy capture in accordance with the present disclosure.

### DETAILED DESCRIPTION OF ILLUSTRATIVE EMBODIMENTS

System Overview. This disclosure is directed to creating new surfaces with intrinsic properties relating to increased durability and color fastness for use on indoor surfaces, including carpets, and outdoor surfaces, including landscapes and sports fields. The disclosure includes using a polyurethane or other type of material to create customizable surfaces for any of a variety of uses and that creates a finished product that can be produced in rolls or tiles depending on the installation technique. As a result, the completed product may be 100% sustainable and recyclable.

The production surface may integrate with various technologies to help create the first truly smart surface. The production process can be customized with each upright strand—be it artificial turf or a form of carpet-being of a different color, shape, density, smell, stiffness, or having some other distinct characteristic. The foundation layer can also be customized which can provide drainage, shock attenuation, and dimensional stability. For the purposes of this disclosure, the term “stem and leaf” or “stem and leaves” will be used to describe one or more individual stands or fibers of artificial surface. It will be understood that the term “stem and leaf” in the disclosure is exemplary and it may include straight strands or fibers with no leaves, carpet or other synthetic flooring or outdoor covering, and the like.

The present disclosure includes technology that includes one or more of the use of three-dimensional molds, product chemistry, manufacturing processes, and artificial intelligence.

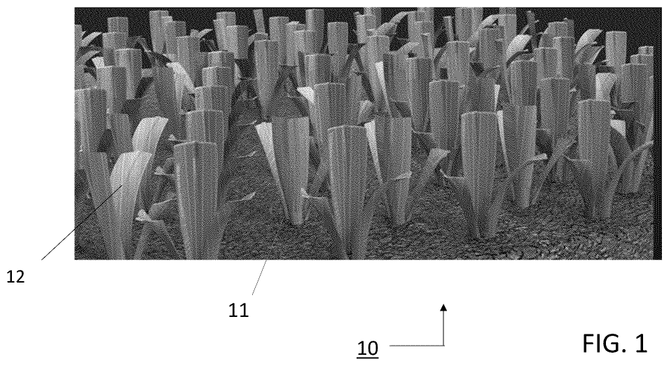

Detailed Description With reference to FIG. 1, there is shown an exemplary turf system 10 having a substrate 11 and blades of grass 12. While this disclosure will be described with reference to artificial turf for a variety of applications, it will be understood by those skilled in the art that the systems and methods disclosed herein are applicable to any type of surface, including carpet, home and business ground cover, parks, and landfills covers.

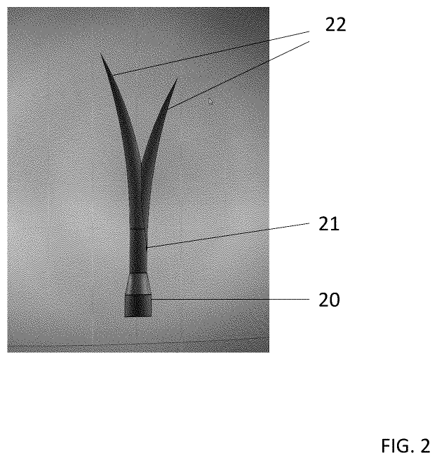

FIG. 2 shows an exemplary blade of artificial grass having a stem 21 and leaves of grass 22. While this figure shows 2 multiple leaves of grass 22, it will be understood that the disclosure includes a variety of the number of leaves, from 0 to n, where n is limited only by the number of grasses being imitated or the number of configuration of fibers being used for the applications. The stem 21 is integrally formed with substrate 20 such that multiple stems may be connected within a common substrate.

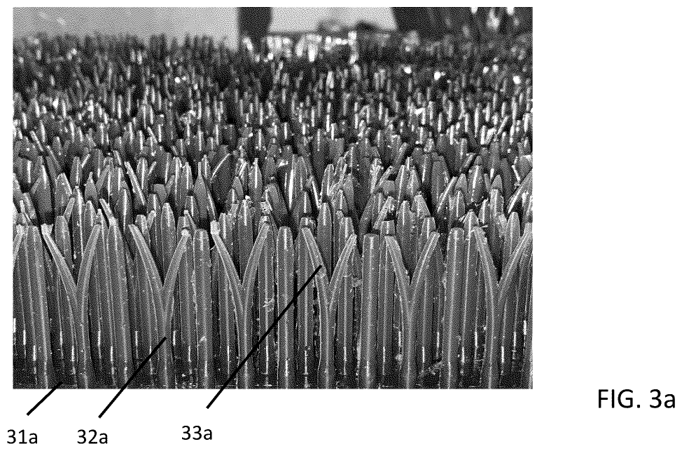

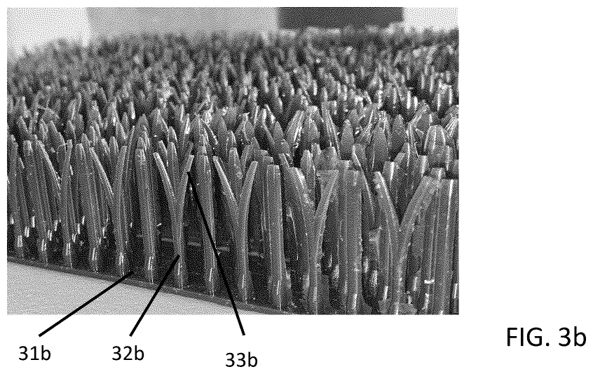

FIGS. 3a and 3b show two views of an exemplary section of turf having a common substrate 31a, 31b constructed in accordance with the present disclosure. There is shown multiple blades of artificial turf, each having a stem 32a, 32b, and multiple leaves 33a, 33b protruding from substrate 31a, 31b.

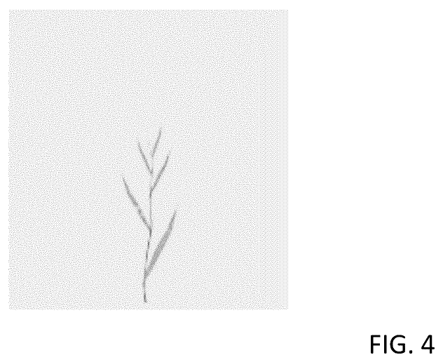

FIG. 4 shows an exemplary alternative embodiment of a section of turf comprising a stem and multiple leaves as a simulated blade of grass. It will be understood that customized molds may be created to form various stem and leaf configurations. Any blade length and thickness of the stem and leaves may be created. It will be also understood that the colors may be adjusted or changed.

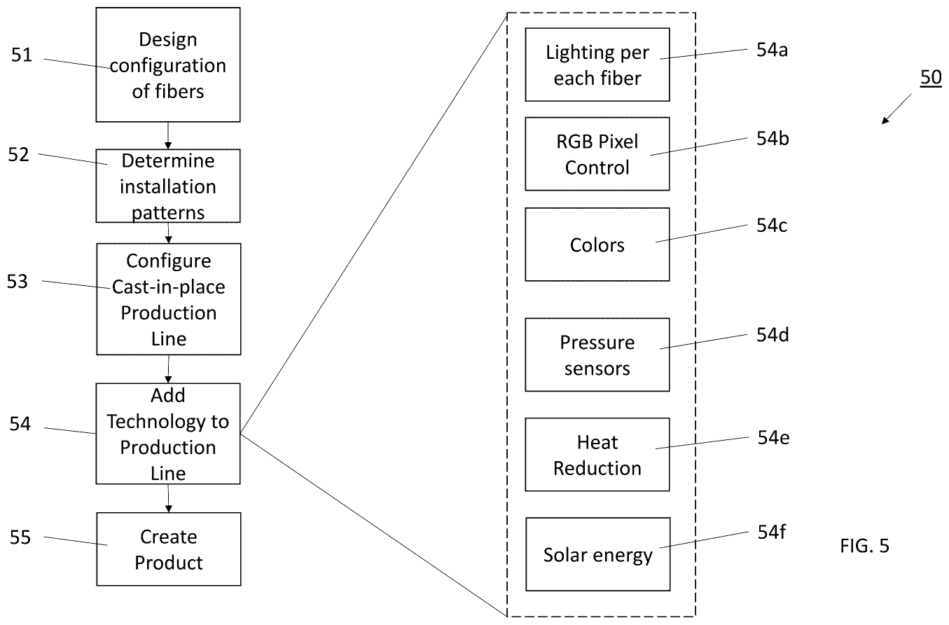

Manufacturing Process. With reference to FIG. 5, there is shown an exemplary process 50 for manufacturing a custom surface in accordance with the present disclosure. At 51, the design or configuration of the fibers is determined. The design or configuration may be implemented using a poured mold process or a 3D printer or other manufacturing techniques. The design may be a customized design, including a simulated grass type or filament design. Various shapes, sizes and densities may be incorporated into the mold.

At 52, the installation pattern may be determined. Such installation patterns may, for example, include panels, rolls, or other installation patterns. The design/configuration patterns and installation patterns are then used to create a cast-in-place” production line at 53 which may involve one or more molds, 3D printing, or CNC machines. At 54, technology, if any, is added to the production line. Such technology may, for example, include lighting for one or more fibers at 54a, Red Green Blue (RGB) pixel control at 54b, one or more colors at 54c, pressure sensors at 54d, heat reduction technology at 54c, and solar energy receptors at 54f. It will be understood that other technologies may be incorporated into the production line at 54. For example, individual LEDs or sensors may be incorporated into each fiber and interconnected via wiring encased in the substrate. At 55, the custom surface is molded by filling the molds with the material that will comprise the surface and the substrate. The material may be inserted as a liquid that will then have time to cure. Once the material is cured, the surface is removed.

Product Chemistry. The present disclosure contemplates the use of product chemistry that would provide longevity, color fastness, i.e., not susceptible to rapid or uneven color degradation from ultraviolet exposure or use, and also have the ability to retain its smell over long periods of time. For example, thermoplastic urethane (TPU), polyurea or other urethane-type products, which may, for example, be a two (2) part curable urethane, and/or a polyvinyl chloride (PVC) material may be used for the individual fiber. Each of these materials may also be injected with scents that can be used for various applications, including for example, scents relating to outdoor grass, indoor cleanliness, fresh scents, or deodorizers which may be used in pet facilities. Every upright strand or stem could have a different scent or technology as needed by end user design.

Product Density or Flexibility Variation. The material used for the customized surface may be selected based on the intended use of the surface. Physical properties such as density and flexibility may be used to select the material and variations of each may be used in different areas or the surface. The height and width of each fiber, and the distance between fibers (i.e. density) may be customized in whole or in part. Every upright strand, fiber, or stem and leaf combination may have a different density, flexibility, height, weight, and thickness that can be customized for the end use.

By way of example, different sports fields may have different product densities and flexibility. Federation Internationale de Football Association (FIFA), the world governing body for soccer, has set standards for the use of artificial turf. The National Football League (NFL) and the NFL Players Association (NFLPA) have a joint committee called the Field Surface & Performance Committee that provides guidance on the safety, performance, and testing of artificial turf. Other sponsoring bodies may have their own requirements. The customized surface of the present disclosure can be adapted to meet or exceed any type of standard with respect to the use case. Additionally, to the extent that sand or other filler material (i.e. sand) is recommended or required, the height, density and flexibility may be adapted to accommodate the filler material.

Adding Technology. Any desired technology may be added to the production. Technology may include, but is not limited to, LED lighting for each fiber, colors, pressure sensors, heat reduction technology, and solar energy receptors. Colors and other technology may be added to the production line in either specific, pre-defined patterns or randomly on a per fiber basis by using LEDs placed within each fiber or a subset of fibers. Heat reduction may be obtained by selecting compounds that reflect light, scatter light, or contain a blend of microscopic hollow spheres to reduce heat retention.

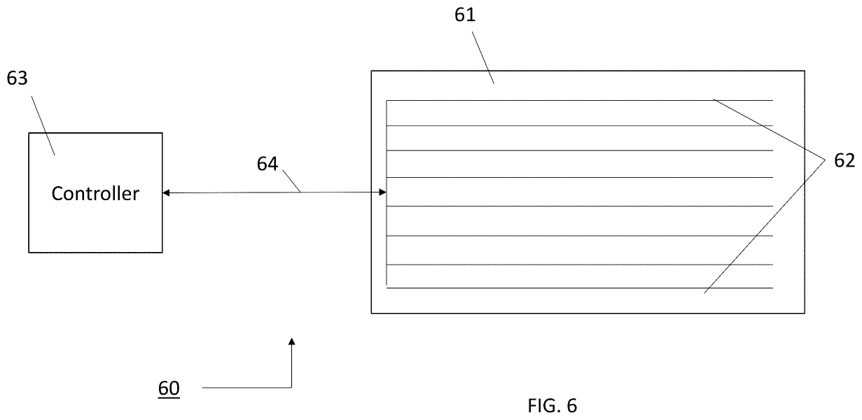

With reference to FIG. 6, there is shown a configuration 60 of a substrate 61 containing a communication network 62 which connects one or more individual fibers with each other and a controller 63. In an embodiment, the controller 63 is an RGB controller which is in communication with one or more pixels embedded in the fibers via the communication network 62. The controller 63 may be programmed to create visual shapes, change of colors, and the like. The controller 63 may be used to control the various color pixels to create customized designs or real time changes in the design patterns. For example, a customized carpet covering at an airport departure gate may display the logo for an airline (i.e., Delta Airlines) at one point in time and then change the logo to that of another airline at another point in time (i.e., American Airlines) depending on the airline that is currently using that gate. As an example of yet another use case, the technology may be used to create welcome mats at hotels and other guest houses to customize greetings to customers arriving at their destination, which may, for example, be tied to a customer's loyalty rewards application or simply welcoming a new guest to a hotel, motel or other rental unit.

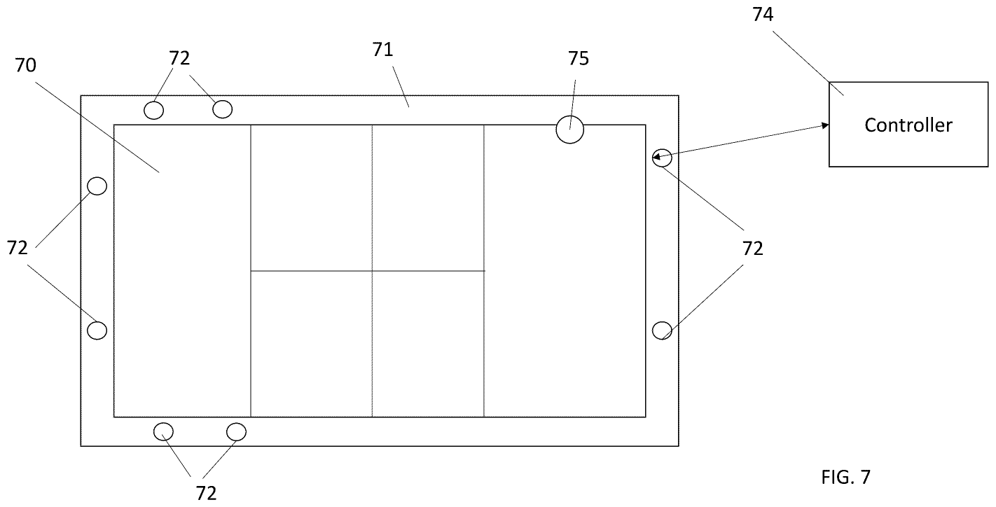

With reference to FIG. 7, pressure sensors 72 connected to a controller 74 may be configured to determine weights or count foot traffic. Such pressure sensors 72 may also be used for determining the location where a ball impacts the surface which may be useful for sports in which a boundary is used to determine whether the ball is in play or out of play. An example use of such pressure sensors 72 is described below.

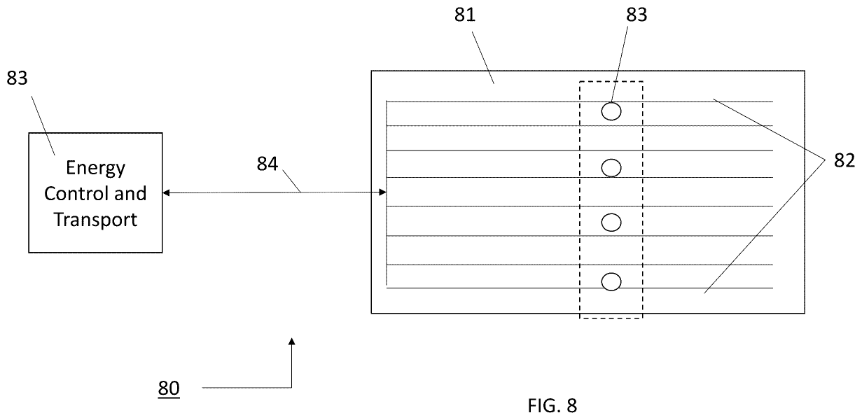

With reference to FIG. 8, solar technology may be used to capture and/or retain energy. Photovoltaic cells shown schematically as 83 may be embedded in the substrate 81 of the surface or in one or more individual fibers to capture solar energy. An electrical network 82 in the substrate 81 may carry the captured solar energy to an energy controller 84 for storage and transport. The energy may be used locally to power on or more controllers or captured and transported for other uses.

Additionally, scents may be added to the production line. One or more scents may be embedded into the surface during the production process. For example, the scents may be embedded through an extrusion process, mixed into the mold, or compounded into the base formula. The scent will be released over time. While the scent released into the ambient environment may be diluted over time, depending on use and environmental conditions, having a scented turf provides several use cases, including but not limited to a variety of indoor applications. Additionally, some scents may last longer than others and therefore be more appropriate for a customized use case.

It will be understood that the above-described technology additions are not mutually exclusive. Any of the technologies may be used with any other technologies. So for example, RGB pixels may be used in conjunction with pressure sensors. Scents may be included in surfaces that include solar power capture. Solar power capture may be used with both RGB pixels and pressure sensors. These combinations are exemplary only and other combinations are included in the present disclosure.

Artificial Intelligence. In an embodiment, artificial intelligence or machine learning algorithms may be used to create or assist in the creation of the computer-generated images. Unless otherwise set forth herein the terms artificial intelligence and machine learning will be used interchangeably and be represented by “AI/ML.”

A machine learning algorithm may be trained on a variety of surfaces using a variety of technology for a variety of applications. The variety of surfaces may include, but are not limited to, different species of grasses or other biological ground cover, various carpet fibers and carpet materials. The technology may include RGB controls, colors, pressure sensors, LEDs, and other technology. The variety of applications may include, for example, sports fields, outdoor recreational spaces, business or home carpet applications, or any other custom flooring application.

The AI/ML algorithms may be implemented on a general-purpose computer programmed to control the creation of the images, in whole or in part, used to generate the molds. Supervised learning models such as classification or regression models, including, for example, linear regression or logistic regression, decision tree analytics, including random forest algorithms, support vector machine (SVM) algorithms, Naives Bayes algorithms, and KNN algorithms, may be used. Unsupervised learning models, such as K-means may also be used.

The inputs to the AI/ML algorithms may include, for example, specific criteria including a desired composition, a desired application, size parameters, color parameters, design patterns, or other input factors. The AI/ML algorithms may then suggest one or more solutions for the proposed application based on the input criteria.

The AI/ML algorithms may also be used to generate the code used to create the images, including, for example, the g-code that controls 3D printers and/or CNC machines that may be used in the production process. Additionally, AI/ML algorithms may be used to create design patterns using the technology, including the programming for the controller associated with the technology.

Use Cases. As set forth above, there are a plurality of use cases for the technology. For example, one embodiment may be for use on artificial turf applications such as those used on a sports field. In an aspect, the turf may be manufactured in rolls to be installed on the field. The turf may have pigments installed at the time of manufacture that, when installed on the field, would provide the line markings for the field of play. In an aspect, a football field may include end zone markings, sideline markings, hash marks and other markings specific to a football field. A soccer field may include touch lines, end lines and goalie boxes and other markings specific to a soccer field.

In an alternative embodiment, embedded technology may be used to temporarily create a sports field. For example, white LEDs on a green surface may be illuminated to create the layout of the football field. That same green surface may be used for a soccer field wherein the layout is illuminated by white LEDs on the green surface in accordance with the dimensions and markings for a soccer match. It will be understood that these turf uses for sports fields are exemplary only.

In an embodiment, pressure sensors may be embedded in the customized surface that would indicate when a ball and/or player steps out of bounds. On a football field, for example, stepping on a white line is considered out of bounds, while in soccer, a ball crossing the touch line in its entirety is considered out of bounds, regardless of where the player is standing. In each case, pressure sensors can detect with high precision when such a condition occurs. This would greatly reduce or eliminate the need for instant replay in a variety of sports.

With reference to FIG. 7, there is shown an exemplary outline of a tennis court 70 constructed in accordance with the present invention. The out-of-bounds lines 71 are equipped with pressure sensors shown schematically as 72. In an embodiment, the pressure sensors are embedded in individual fibers in the surface within the out-of-bounds lines 71 and would enclose the playing surface. The pressure sensors are connected to controller 74 via substrate (not shown in FIG. 7). The pressure sensors may be embedded in the manufacturing process and be always active. Alternatively, the controller 74 may turn the sensors on/off or adjust the detection thresholds (i.e., the difference between a tennis ball and a tennis player) such that the sensitivity of the pressure sensors may be varied based on the application. In this example, tennis ball 75 hits the out-of-bounds line 71. The pressure sensors 72 detect the pressure and communicate the pressure to the controller 74. The controller, based on input thresholds, determines that the detected pressure is the expected pressure of a tennis ball as opposed to a player and the controller will thereby make an out-of-bounds determination.

In accordance with another aspect, the manufacturing process may include color variations on a stem-by-stem or area-by-area basis to create logos, lines, advertisements or the like. In an aspect, the stems may be of a uniform color and embedded pixels may be used to create such logos, lines, advertisements, or the like. In the former case, the logos, lines or advertisements would be permanent, in the latter, the logos, lines or advertisements may be temporary and changeable.

The customized surfaces of the present disclosure may be embodied in carpet applications, including residential, hospitality or commercial settings. Customized welcome mats may be created. Likewise novelty rugs and other residential indoor or outdoor applications may be created.

One particular application may be to install the customized surfaces on the edges of runways at airports. Such turf with embedded technology may be used for lights and warnings along the edges of runways.

In another use case, the customized surface may be used as a landfill cover. Various color schemes may be employed to have the landfill cover match the local terrain. Scents may also be added to mask the odor from the landfill cover.

In summary, the features may include, but are not limited to the following, (i) 3D-printed custom design for artificial turf; (ii) use of molds representing individual fibers, for example, Bermuda/Kentucky Blue Grass/generic/or customized surface textures or fibers; (iii) cast in place production; (iv) production process variables including the customization of color, shapes, and or scents; (v) manufacturing in panels, rolls, and in custom sizes; and (vi) inclusion of technology, such as lighting, RGP pixel control, weight detecting for foot traffic, solar energy capture, scents, ball impact readings and playground applications.

### Information Technology, Hardware, and Software

The present disclosure contemplates a computer program to create customized patterns and molds for various surfaces, as well as controllers for controlling the use of technology embedded in the surface.

The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, Compact Disc-Read-Only Memory devices (CD-ROMs), Digital Versatile Discs, or, Digital Video Discs (DVDs), hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices may be practiced in the form of program, which, when implemented on a general-purpose processor, the program code combines with the processor to provide a unique device that operates to invoke the functionality of the system.

While the present system has been described in connection with the various examples of the various figures, it is to be understood that other similar implementations may be used, or modifications and additions may be made to the described examples of a telecommunications system without deviating therefrom. Therefore, the disclosure as described herein should not be limited to any single example, but rather should be construed in breadth and scope in accordance with the appended claims.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope of the disclosed subject matter is defined by the claims and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

What is claimed:

1. An artificial surface comprising:
a substrate configured to support the artificial surface;
a plurality of fibers formed integrally with and protruding upward from the substrate, wherein each of the plurality of fibers is individually molded; and
a controller coupled to one or more of the plurality of fibers, wherein the controller is configured to control technology embedded in the one or more of the plurality of fibers.

2. The artificial surface of claim 1, further comprising one or more pixels embedded in the one or more of the plurality of fibers, and wherein the controller is a red-green-blue (RGB) controller and is configured to control a light emanating from the one or more pixels to create a first pattern.

3. The artificial surface of claim 2 wherein the RGB controller is configured to change the light emanating from the one or more pixels to create a second pattern.

4. The artificial surface of claim 3 wherein the first pattern comprises a layout of a first sports field and the second pattern comprises a layout of a second sports field.

5. The artificial surface of claim 2 wherein the first pattern is a first design, and wherein the controller is configured to change the light emanating from the one or more pixels to create a second pattern, wherein the second pattern is a second design.

6. The artificial surface of claim 2 further comprising one or more pressure sensors embedded in the one or more of the plurality of fibers.

7. The artificial surface of claim 6 wherein the RGB controller is further configured to (a) receive a pressure reading from the one or more pressure sensors, (b) compare the pressure reading to a threshold, and (c) create a signal based on the comparing step.

8. An artificial surface comprising:
a substrate configured to support the artificial surface;
a plurality of fibers formed integrally with and protruding upward from the substrate, wherein each of the plurality of fibers is individually molded and wherein a first subset of the plurality of fibers comprises a first shape and a second subset of the plurality of fibers comprises a second shape.

9. The artificial surface of claim 8 wherein characteristics of the plurality of fibers may be adjusted based on individual molds for the plurality of fibers.

10. The artificial surface of claim 9 wherein the characteristics are one of density, height or flexibility of the fibers.

11. The artificial surface of claim 9 wherein a first subset of the plurality of fibers has a first color and a second subset of the plurality of fibers has a second color.

12. The artificial surface of claim 1 wherein one or more of the plurality of fibers has a scent embedded therein.

13. A method for creating a custom surface comprising:
designing a configuration of fibers;
configuring a cast-in-place production line based on the configuration of fibers,
wherein the cast-in-place production line includes molds for individual fibers and an integral substrate;
filling the molds with a compound; and
adding technology to one or more of the molds.

14. The method of claim 13 wherein the adding technology step comprises adding technology within one or more of the molds for individual fibers and adding technology to the substrate.

15. The method of claim 14 wherein the adding technology within the one or more of the molds for individual fibers comprises one or more pixels and the technology in the substrate comprises connection between the one or more of the molds for individual fibers having the one or more pixels and wherein the connection is configured to be in communication with a controller.

16. The method of claim 14 wherein the adding technology within the one or more of the molds for individual fibers comprises one or more pressure sensors and the technology in the substrate comprises connection between the one or more of the molds for individual fibers having the one or more pressure sensors and wherein the connection is configured to be in communication with a controller.

17. The method of claim 14 wherein the adding technology step comprises adding photovoltaic cells to the one or more of the molds or to the substrate.

18. The method of claim 14 wherein the compound comprises a light reflecting property.

19. An artificial surface comprising:
a substrate configured to support the artificial surface;
a plurality of fibers formed integrally with and protruding upward from the substrate, wherein each of the plurality of fibers is individually molded;
one or more pressure sensors embedded in the one or more of the plurality of fibers; and
a controller coupled to one or more of the plurality of fibers.

20. The artificial surface of claim 19 wherein the controller is configured to (a) receive a pressure reading from the one or more pressure sensors, (b) compare the pressure reading to a threshold, and (c) create a signal based on the comparing step.
